(19) United States
(12) Patent Application Publication
(10) Pub. No.: US 2004/0009710 A1
(43) Pub. Date: Jan. 15, 2004

(54) Metal wire frame

(76) Inventor: Yuan-Huei Peng, Taipei (TW)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/423,260

(22) Filed: Apr. 25, 2003

(30) Foreign Application Priority Data
Apr. 26, 2002 (TW) 091205836

(51) Int. Cl. H01R 24/00

(52) U.S. Cl. 439/676

(57) ABSTRACT

A metal wire frame applied to be connected to a plug for transmitting a net signal is provided, which includes a frame body, and at least a metal wire installed on the frame body and having a curved part for contacting with a metal contact of the plug and a vertical part connected to the curved part of the metal wire to transmit the net signal so that the metal wire gains a short route.

### FIELD OF THE INVENTION

The present invention relates to a metal wire frame, and more particularly to a metal wire frame for connecting to a plug so as to transmit a net signal.

### BACKGROUND OF THE INVENTION

Generally, a keystone jack for transmitting a net signal has a metal wire frame mounted therein. The metal wire frame has a plurality of metal wires to connect a plug with a printed circuit board (PCB). The metal wires are usually installed inside the metal wire frame. The metal wire frame with metal wires can be used for a keystone jack or a keystone panel. Please refer to FIGS. 1-2. FIG. 1 is a three-dimensional diagram showing the conventional keystone jack according to the prior art. FIG. 2 is a three-dimensional diagram showing the conventional metal wire frame mounted inside the keystone jack of FIG. 1 according to the prior art. The metal wire frame 21 can be mounted inside the keystone jack 10, which has eight metal wires 20 as shown in FIG. 2. Please refer to FIG. 3. FIG. 3 is a three-dimensional diagram showing the metal wire frame installed in the keystone jack according to the prior art. The keystone jack 10 and the insulation displacement connector 30 are installed on the printed circuit board 31. When the plug 40 for transmitting a net signal is plugged into the keystone jack 10, the eight metal wires 20 will be separated by the grate-like comb 32 mounted on the plug 40. Then, the metal wires 20 are inserted into the spaces 33 between the teeth of the grate-like comb 32. Therefore, the metal wires frame 21 inside the keystone jack 10 will be fixed and engaged with the plug 40.

Please refer to FIGS. 4-5. FIG. 4 is a side view showing the initial contact stage of the plug and the metal wire frame according to the prior art. FIG. 5 is a side view showing the final contact stage of the plug and the metal wire frame according to the prior art. When the plug 40 is plugged into he keystone jack 10, the metal contact piece 41 contacts with the starting point 42 of the metal wire 20. Then, the metal wire 20 will be pressed downwards by the metal contact piece 41 from the initial height HI to the final height HF. At this time, the metal contact piece 41 contacts with the terminal point 50 of the metal wire 20. The sliding distance SD between the starting point 42 and the terminal point 50 on the metal wire 20 is shown in FIG. 4. Obviously, he metal wire 20 transmits the net signal via a circuitous route 43 to the printed circuit board 31. Therefore, the extra materials of the metal wires for manufacturing the circuitous route 43 are necessary, which increase the cost.

In view of foregoing reasons, it is known that how to desigh a shorter route for transmitting a net signal and thereby reduce the materials costs have become a major problem waited to be solved in the industry. The present invention provides the metal wire frame, which is able to reduce the route of the metal wire for transmitting the net signal.

### SUMMARY OF THE INVENTION

It is an object of the present invention to provide the metal wire frame having the particular metal wire mounted thereon. The metal wire has the curved part for connecting with the metal contact of the plug so that the metal wire gains the short route. Also, the signal intensity loss caused by the circuitous route can be reduced.

It is another object of the present invention to provide the metal wire frame, in which the metal wire has the vertical part which is perpendicular to the metal wire frame so that he metal wire gains the short route for transmitting the net signal.

It is another object of the present invention to provide the metal wire frame, in which the metal wire has the curved part with the arcuate shape. The metal wires are installed perpendicularly on the metal wire frame so that the metal wire gains the short route.

According to one aspect of the present invention, a metal wire frame applied to be connected to a plug for transmitting a net signal includes: a frame body, and at least a metal wire installed on the frame body and having a curved part for contacting with a metal contact of the plug and a vertical part connected to the curved part of the metal wire to transmit the net signal so that the metal wire gains a short route.

Preferably, he plug exerts a pushing pressure upon the metal wire so as to bring the metal wire a pushed distance thereon.

Preferably, the pushing pressure causes a contact pressure produced between the plug and the metal wire and is kept above 100 grams.

Preferably, the curved part of the metal wire has an arcuate shape, so as to well contact with the metal contact of the plug.

Preferably, the metal wire has a rectangular cross-section so as to be securely fixed in the frame body.

Preferably, the cured part of he metal wire has a circular cross-section so as to be fixed in the frame body.

Preferably, the curved part presents a “[”, “C” or “(” form so as to contact the metal contact of the plug.

Preferably, the curved part further has an extended part, so as to easily set in a grate-like comb of the plug.

According to another aspect of the present invention, a metal wire frame for connecting with a plug to transmit a net signal includes a frame body, and at least a metal wire installed in the frame body and having a curved part contacted with a metal contact of the plug to transmit the net signal, so that the metal wire gains a short route.

Preferably, he metal wire further includes a vertical part connected with the curved part and is perpendicular to he frame body to transmit the net signal to a printed circuit board of a socket.

Preferably, the net signal is transmitted to a printed circuit board.

The above objects and advantages of he present invention will become more readily apparent to those ordinarily skilled in the art after reviewing the following detailed description and accompanying drawings, in which:

### BRIEF DESCRIPTION OF THE DRAWINGS

FIG. 1 is a three-dimensional diagram showing the conventional keystone jack according to the prior art;

FIG. 2 is a three-dimensional diagram showing the conventional metal wire frame mounted inside the keystone jack of FIG. 1 according to the prior art;

FIG. 3 is a three-dimensional diagram showing the metal wire frame installed in the keystone jack according to the prior art;

FIG. 4 is a side view showing the initial contact stage of the plug and the metal wire frame according to the prior art;

FIG. 5 is a side view showing the final contact stage of the plug and the metal wire frame according to the prior art;

FIG. 6 is a three-dimensional diagram showing the metal wire frame according to a preferred embodiment of the present invention;

FIG. 7 is a side view showing the initial status when the metal wire is pushed by the plug according to a preferred embodiment of the present invention;

FIG. 8 is a side view showing the final status when the metal wire is pushed by the plug according to a preferred embodiment of the present invention;

FIG. 9 is a cross-section view of the metal wires shown in FIG. 6 of the present invention;

FIG. 10 is a side view showing the metal wire frame according to another preferred embodiment of the present invention; and

FIG. 11(a ) and (b) are side views showing different types of metal wire frames according to another two embodiments of the present invention.

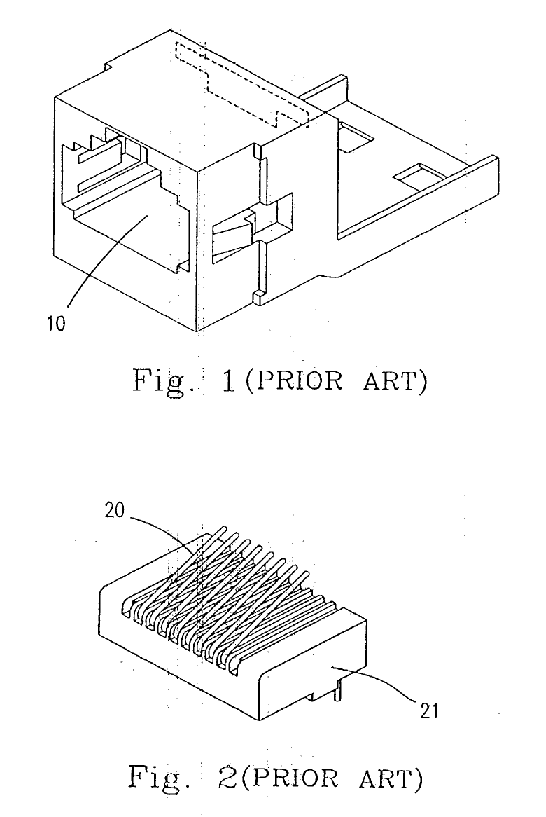

### DETAILED DESCRIPTION OF THE PREFERRED EMBODIMENT

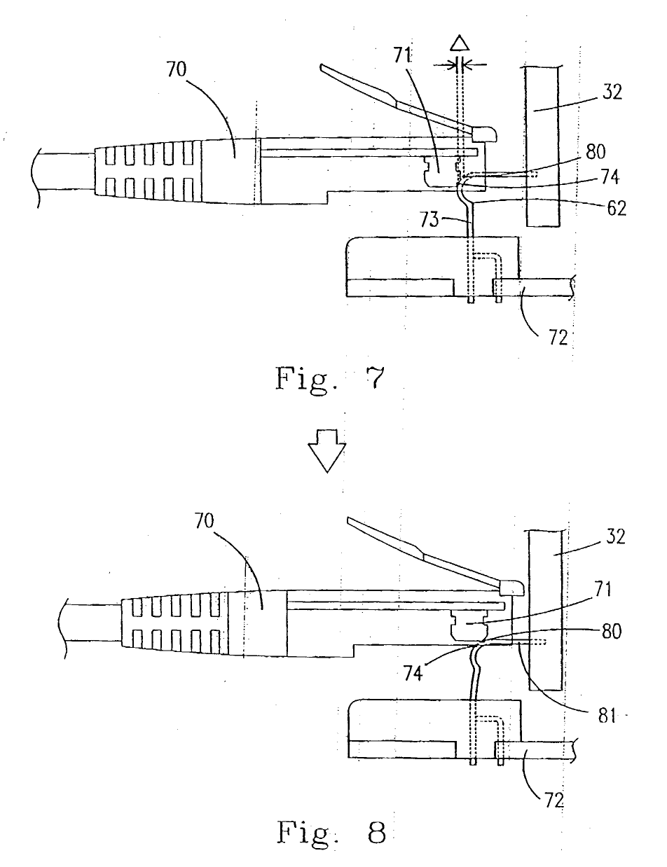

Please refer to FIG. 6 and FIG. 7. The metal wire frame 60 is applied to connect with the plug 70 for transmitting a net signal. The metal wire frame 60 includes the frame body 61 and the metal wires 62 which are mounted on the frame body 61. The metal wire 62 has the curved part 63 for contacting with the metal contact 71 of he plug 70 shown in FIG. 7. The metal wire 62 also has the vertical part 64 connected with the curved part 63 for transmitting the net signal to the PCB 72 so that the metal wire 62 gains a short route 73.

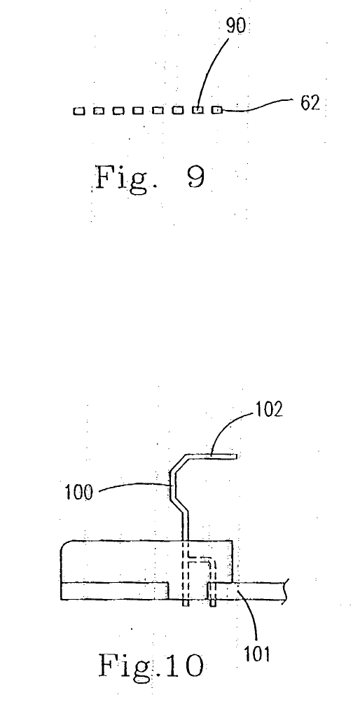

Please refer to FIGS. 7-8. When the metal wire 62 is pressed by the plug 70, a pushing pressure is produced. The metal contact 71 is connected with the contact point 74 of the metal wire 62. Meanwhile, the metal contact 71 pushes the metal wire 62 forward to produce a pushing distance Δ. The pushing pressure causes a contact pressure generated between the plug 70 and the metal wire 62. The contact pressure is kept above 100 grams. Ultimately, the metal contact 71 reaches the contact terminal 80 and the plug 70 is fixed. The curved part 63 of the metal wire 62 is an arc shape so as to well contact with the metal contact 71 of the plug 70. Please refer to FIG. 9. FIG. 9 is a cross-section view of the metal wires shown in FIG. 6 of the present invention. The eight metal wires 62 have the rectangular cross-sections 90 so that the metal wires can be securely fixed in the frame body 61. The cross-section of the metal wires can be changed into a circular form too so as to be fixed in the frame body 61.

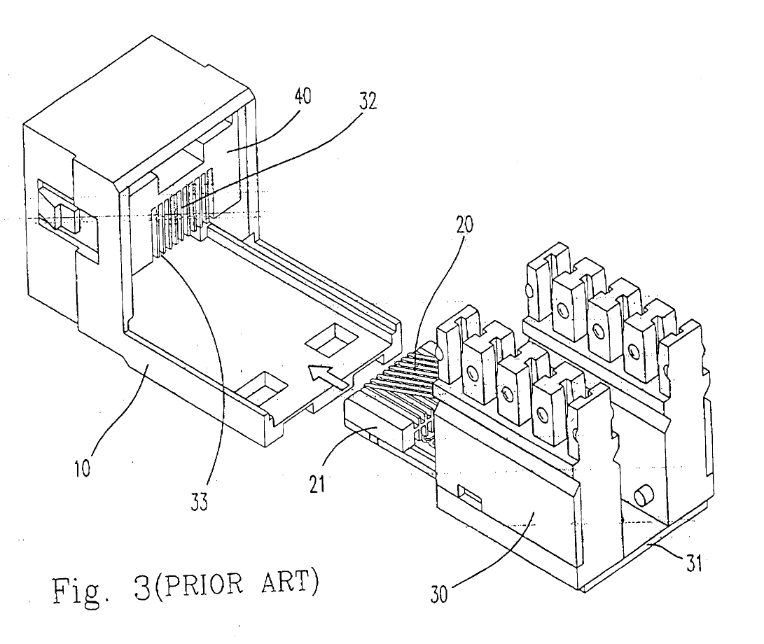

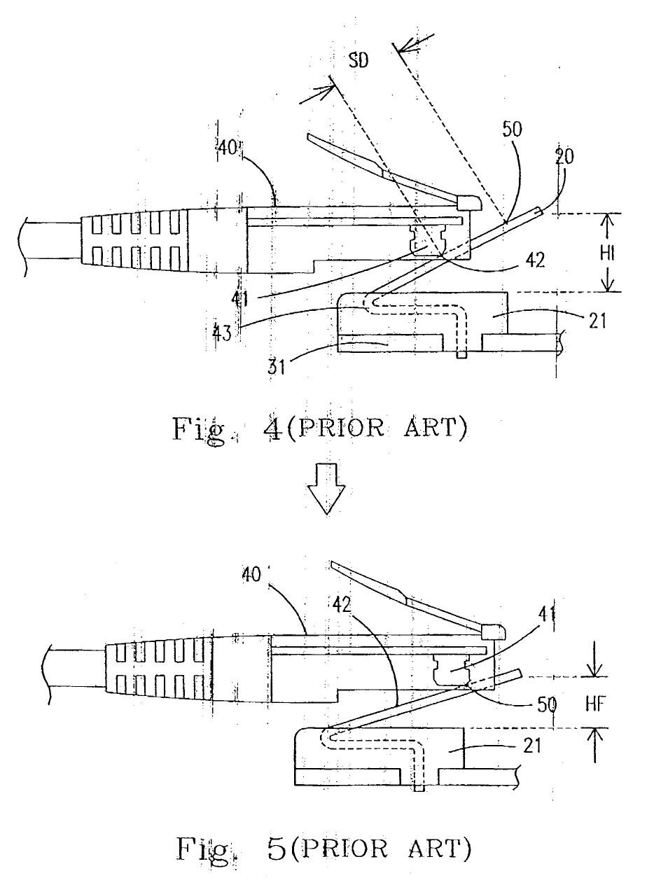

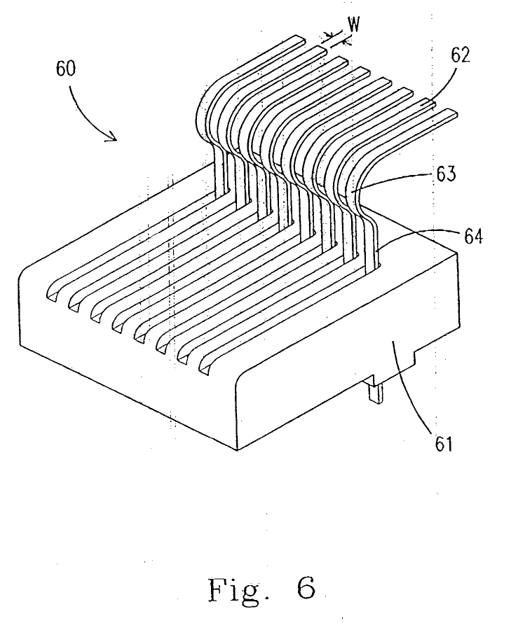

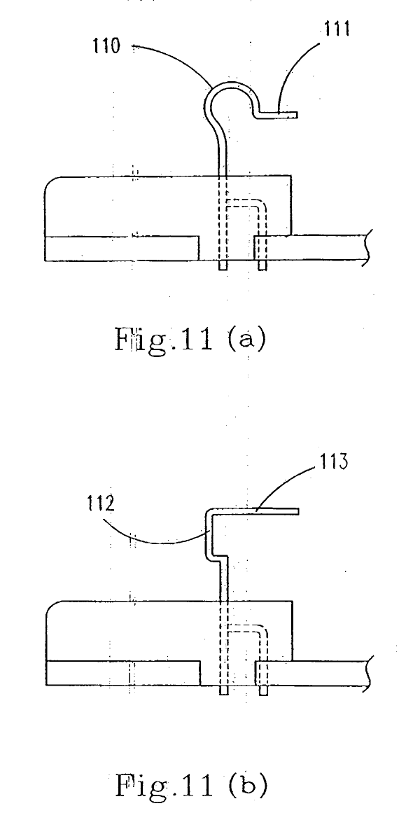

Please refer to FIGS. 10-11. FIGS. 10-11 are side views showing the metal wire frame having different forms of metal wires. The curved part 63 of the metal wire 62 can be changed into a “(” form 100 (as shown in FIG. 10), a “C” form 110 (as shown in FIG. 11(a)) and a “[” form 112 (as shown in FIG. 11(b)) so as to contact with the metal contact 71 of he plug 70. In FIG. 8, FIG. 10, FIG. 11(a) and 11(b), the curved part 63 further includes the extended parts 81, 102, 111 and 113 respectively for easily setting in the grate-like comb 32 of the plug 40 (shown in FIG. 3). The metal wires 62 having the extended parts 81, 102, 111 and 113 will be mounted in the spaces 33 between the teeth of the grate-like comb 32.

According to another embodiment of the present invention, a metal wire frame applied to be connected to a plug for transmitting a net signal is provided. The metal wire frame 60 includes the frame body 61 and at least one metal wire 62 installed on the frame body 61. The metal wire 62 has the curved part 63 contacted with the metal contact 71 of the plug 70 for transmitting the net signal to the PCB 72 so that the metal wire 62 gains the shorter route. The metal wire frame 60 can further include the vertical part 64 connected with the curved part 63 of the metal wire 62. The metal wire 62 is perpendicular to the frame body 61 for transmitting he net signal to the PCB 72.

Therefore, the present invention provides the metal wire frame having the metal wires with the curved parts for reducing the route length when transmitting he net signal through the metal wires. And, the metal wire further includes the vertical part which is perpendicular to the frame body so as to reduce the intensity consumption of the net signal during transmitting. Thus, the metal wire frame is very suitable for manufacturing in the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within he spirit and scope of the appended claims, which are to be accorded wit the broadest interpretation so as to encompass all such modifications and similar structures.

What is claimed is:

1. A metal wire frame applied to be connected to a plug for transmitting a net signal, comprising:
a frame body; and
at least a metal wire installed on said frame body and having a curved part for contacting with a metal contact of said plug and a vertical part connected to said curved part of said metal wire to transmit said net signal so that said metal wire gains a short route.

2. The metal wire frame according to claim 1, wherein said plug exerts a pushing pressure upon said metal wire so as to bring said metal wire a pushed distance thereon.

3. The metal wire frame according to claim 2, wherein said pushing pressure causes a contact pressure produced between said plug and said metal wire and is kept above 100 grams.

4. The metal wire frame according to claim 1, wherein said curved part of said metal wire has an arcuate shape, so as to well contact with said metal contact of said plug.

5. The metal wire frame according to claim 1, wherein said metal wire has a rectangular cross-section so as to be securely fixed in said frame body.

6. The metal wire frame according to claim 1, wherein said curved part of said metal wire has a circular cross-section so as to be fixed in said frame body.

7. The metal wire frame according to claim 1, wherein said curved part presents a “[”, “C” or “(” for so as to contact said metal contact of said plug.

8. The metal wire frame according to claim 1, wherein said curved part further has an extended part, so as to easily set in a grate-like comb of said plug.

9. A metal wire frame for connecting with a plug to transmit a net signal, comprising:
a frame body; and
at least a metal wire installed in said frame body and having a curved part contacted with a metal contact of said plug to transmit said net signal, so that said metal wire gains a short route.

10. The metal wire frame according to claim 9, wherein said metal wire further includes a vertical part connected with said curved part and is perpendicular to said frame body to transmit said net signal to a printed circuit board of a socket.

11. The metal wire frame according to claim 9, wherein said net signal is transmitted to a printed circuit board.
